(19) United States
(12) Patent Application Publication
(10) Pub. No.: US 2009/0006108 A1
(43) Pub. Date: Jan. 1, 2009

(54) Creating A Session Log For A Computing Device Being Studied For Usability

(76) Inventors: William K. Bodin, Austin, TX (US); Ann M. Maynard, Austin, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/769,235

(22) Filed: Jun. 27, 2007

(51) Int. Cl. G06Q 10/00; G06F 17/40

(52) U.S. Cl. 705/1

(57) ABSTRACT

Methods, systems, and products are disclosed for creating a session log for a computing device being studied for usability that include: recording, by a usability expert in a session log, usability observations observed by the usability expert during a usability session for studying the interaction of a user with a computing device; detecting, by an event listener on the computing device, an event generated as a result of user interaction with the device; notifying, by the event listener, a usability engine of the event; and recording, by the usability engine, a description of the event in the session log.

### BACKGROUND OF THE INVENTION

1. Field of the Invention

The field of the invention is data processing, or, more specifically, methods, systems, and products for creating a session log for a computing device being studied for usability.

2. Description Of Related Art

When computer architects design a computing device and its software, these architects often make a great effort to ensure that the device is convenient and easy to use from the perspective of a user. For example, the buttons on the device should be easily accessible when needed for device interaction, while not hindering the user's interaction with the device when the buttons are not in use. As a further example, the graphical user interface of a device should be logically arranged and configured from the user's perspective such that the user's interaction with the device is intuitive for the user.

To ensure that a computing device is convenient and easy to use from a user's perspective, computer architects typically perform usability studies on the interaction of a user with the computing device. Usability refers to a full range of aspects that impact a user's success and satisfaction when interacting with the device. Usability encompass issues such as, for example, a user's understanding of how to operate the device's interface, the ease with which a user is able to physically manipulate the device and its controls, a user's emotions while interacting with the device, the correspondence between the user's desired output from the device and the output actually produced by the device, and so on. In studying a device's usability, high usability is generally regarded as a desirable feature of the device.

Usability studies have traditionally been conducted by having a usability expert observe a user interacting with a computing device and record the expert's observations in a log. The drawback to this traditional approach to studying usability is that the information recorded in the log is limited to the observations capable of being observed by a usability expert. As devices have become smaller and more complex, the ability of a usability expert to observe importance aspects affecting the user's interaction with a computing device is greatly diminished. In particular, some aspects of the user's interaction may not be observable at all. As such, readers will appreciate that room for improvement exists in the area of studying the usability of a computing device.

### SUMMARY OF THE INVENTION

Methods, systems, and products are disclosed for creating a session log for a computing device being studied for usability that include: recording, by a usability expert in a session log, usability observations observed by the usability expert during a usability session for studying the interaction of a user with a computing device; detecting, by an event listener on the computing device, an event generated as a result of user interaction with the device; notifying, by the event listener, a usability engine of the event; and recording, by the usability engine, a description of the event in the session log.

The foregoing and other features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for creating a session log for a computing device being studied for usability according to embodiments of the present invention.

FIG. 2 sets forth a block diagram of automated computing machinery comprising an exemplary computing device useful in creating a session log for a computing device being studied for usability according to embodiments of the present invention.

FIG. 3 sets forth a flow chart illustrating an exemplary method of creating a session log for a computing device being studied for usability according to embodiments of the present invention.

FIG. 4 sets forth a flow chart illustrating a further exemplary method of creating a session log for a computing device being studied for usability according to embodiments of the present invention.

FIG. 5 sets forth a flow chart illustrating a further exemplary method of creating a session log for a computing device being studied for usability according to embodiments of the present invention.

FIG. 6 sets forth a flow chart illustrating a further exemplary method of creating a session log for a computing device being studied for usability according to embodiments of the present invention.

### DETAILED DESCRIPTION OF EXEMPLARY EMBODIMENTS

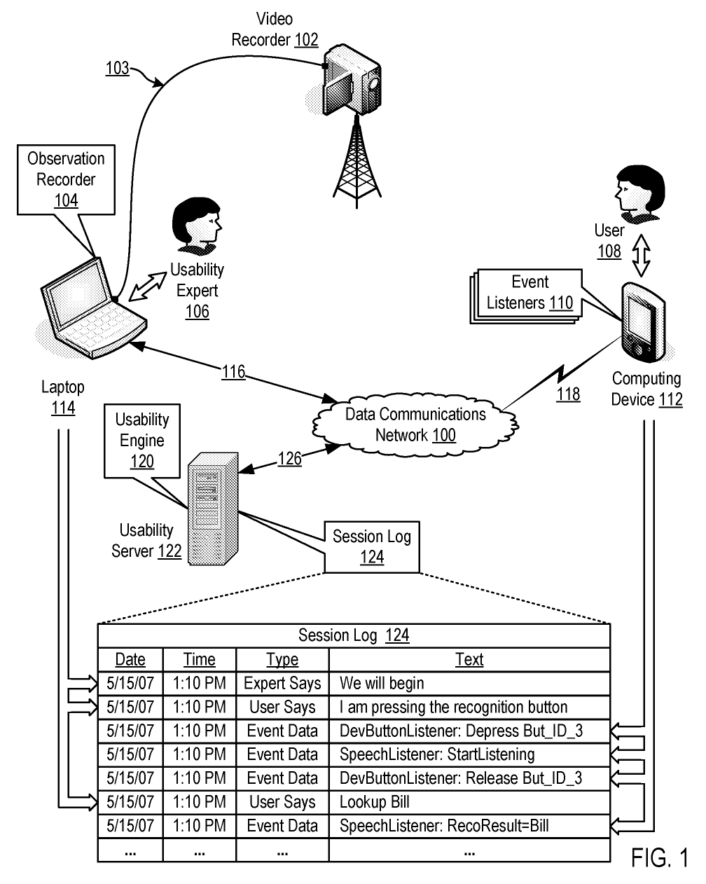

Exemplary methods, systems, and products for creating a session log for a computing device being studied for usability in accordance with the present invention are described with reference to the accompanying drawings, beginning with FIG. 1. FIG. 1 sets forth a network diagram of a system for creating a session log for a computing device being studied for usability according to embodiments of the present invention. The exemplary system of FIG. 1 operates generally for creating a session log for a computing device being studied for usability according to embodiments of the present invention as follows: A usability expert (106) records usability observations in a session log (124) observed by the usability expert (106) during a usability session for studying the interaction of a user (108) with a computing device (112). An event listener (110) on the computing device (112) detects an event generated as a result of user interaction with the device (112) and notifies a usability engine (120) of the event. The usability engine (120) then records a description of the event in the session log (124).

The exemplary system of FIG. 1 includes a computing device (112) connected to a data communications network (100) through wireless connection (118). The computing device (112) of FIG. 1 is being studied for usability by a usability expert (106). The usability expert (106) is a person who specializes in the study of how people interact with and use computing devices. A usability expert may possess general knowledge regarding the field of usability or may specialize in certain aspects of usability. For example, a usability expert may specialize as a cognitive psychologist, user interface specialist, an application expert, a language specialist, and so on.

In the exemplary system of FIG. 1, readers will note that the computing device (112) is implemented as a personal digital assistant (‘PDA’). Readers will note, however, that such an implementation is for example only and not for limitation. In fact, the computing device (112) may be implemented as any general-purpose or special-purpose computing device as will occur to those of skill in the art. Examples of computing devices may include desktop computers, laptop computers, cell phones, gaming consoles, PDAs, personal video recorders, and any other computing device as will occur to those of skill in the art.

In the example of FIG. 1, the usability expert (106) observes the user (108) interacting with the computing device (112) directly or through the use of a video recorder (102). When the observing the user (108) interacting with the computing device (112) through the use of the video recorder (102), the usability expert (106) may observe the user's interaction with the device (112) through the viewfinder on the video recorder (102) or on the display screen of the laptop (114), which is connected to the video recorder (102) using a data communications cable (103). Depending on whether the video recorder (102) is implemented using analog or digital technology, the data communications cable (103) may be implemented as a Component Video cable, S-Video cable, Composite Video cable, Serial Digital Interface cable, FireWire cable, High-Definition Multimedia Interface Cable, and so on.

The exemplary system of FIG. 1 includes a laptop (114) connected to the data communications network (100) through wireline connection (116). The laptop (114) of FIG. 1 has installed upon an observation recorder (104). The observation recorder (104) of FIG. 1 is a software component that supports creating a session log for a computing device being studied for usability according to embodiments of the present invention. The observation recorder (104) of FIG. 1 supports creating a session log for a computing device being studied for usability according to embodiments of the present invention by accepting as input observation data from the usability expert (106) and providing the observation data to a usability engine (120) for storage in the session log (124) on the usability server (122). Using the observation recorder (104), the usability expert (106) of FIG. 1 records usability observations in a session log (124) that the usability expert observed during a usability session for studying the interaction of a user (108) with the computing device (112) according to embodiments of the present invention. A usability session is a period of time dedicated by a usability expert to study the usability of a particular computing device.

In the example of FIG. 1, the observation recorder (104) may provide the observation data to a usability engine (120) using data communications architectures such as, for example, web services, CORBA, Java™ Remote Method Invocation API, and so on. ‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

In the exemplary system of FIG. 1, the computing device (112) has installed upon it several event listeners (110). An event listener is a software component that detects the occurrence of an event that was generated as a result of user interaction with the device (112). The event listeners (110) of FIG. 1 may be able to detect the occurrence of events such as, for example, when a user depresses or releases a button on the device (112), when the user selects components on the device's graphical user interface, when software on the device processes a user's request or provides the user with output, and so on. An event listener may be implemented as interrupt handler, instrumentation code having instrumentation hooks embedded in other software components, a subroutine called by another software module, or any other implementation as will occur to those of skill in the art. In the example of FIG. 1, each event listener (110) operates for creating a session log for a computing device being studied for usability according to embodiments of the present invention. Each event listener (110) of FIG. 1 operates for creating a session log for a computing device being studied for usability according to embodiments of the present invention by detecting an event generated as a result of user interaction with the device and notifying the usability engine (120) of the event. In the example of FIG. 1, each event listener (110) may notify the usability engine (120) of the event using data communications architectures such as, for example, web services, CORBA, Java™ Remote Method Invocation API, and so on.

The exemplary system of FIG. 1 also includes a usability server (122) connected to the data communications network (100) through wireline connection (126). The usability server (122) of FIG. 1 has installed upon it a usability engine (120). The usability engine (120) is a software component that receives event notifications from one or more event listeners (110) and administers the session log (124). The usability engine (120) of FIG. 1 includes computer program instructions configured for creating a session log for a computing device being studied for usability according embodiments of the present invention. The usability engine (120) of FIG. 1 operates generally for creating a session log for a computing device being studied for usability according embodiments of the present invention by recording, in the session log (124), a description of the event provided by one of the event listeners (110) on the computing device (112).

The session log (124) of FIG. 1 is a data structure that stores information provided by a usability expert that describes an interaction of a user with a computing device during a usability session and information provided by one or more event listeners that is generate as a result of the user interaction with the device. A session log may be implemented as a table of a database, text file, or any other implementation as will occur to those of skill in the art. In the example of FIG. 1, the session log (124) is implemented as a table. Each record of the table represents observation data provided by the usability expert (106) or an event detected by one of the event listeners (110) on the computing device (112). Each record includes a ‘Date’ field that indicates the date on which the record was recorded by the usability engine (120). Each record includes a ‘Time’ field that indicates the time at which the record was recorded by the usability engine (120). Each record includes a ‘Type’ field that specifies whether the record represents an observation by the usability expert (106) or an event detected by one of the event listeners (110). A value of ‘Event Data’ for the ‘Type’ field indicates that the record represents an event detected by one of the event listeners (110). Any other value indicates that the record represents an observation by the usability expert (106) and specifies the type of observation made. Each record also includes a ‘Text’ field. When the record represents an observation by the usability expert (106), the ‘Text’ field stores the details of the expert's observations. When the record represents an event detected by one of the event listeners (110), the ‘Text’ field stores the event listener identifier of the event listener detecting the event along with the details of the event.

Readers will note that the usability engine (120) and the session log (124) are installed on a usability server (122) in the example of FIG. 1. Such an embodiment, however, is for example and explanation, not for limitation. In other embodiments of the present invention, the usability engine and the session log may be installed on the computer used by the usability expert (106) to input the usability expert's observations. In such embodiments, the functions described above as being performed by the observation recorder (104) may be merged into the usability engine (120).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

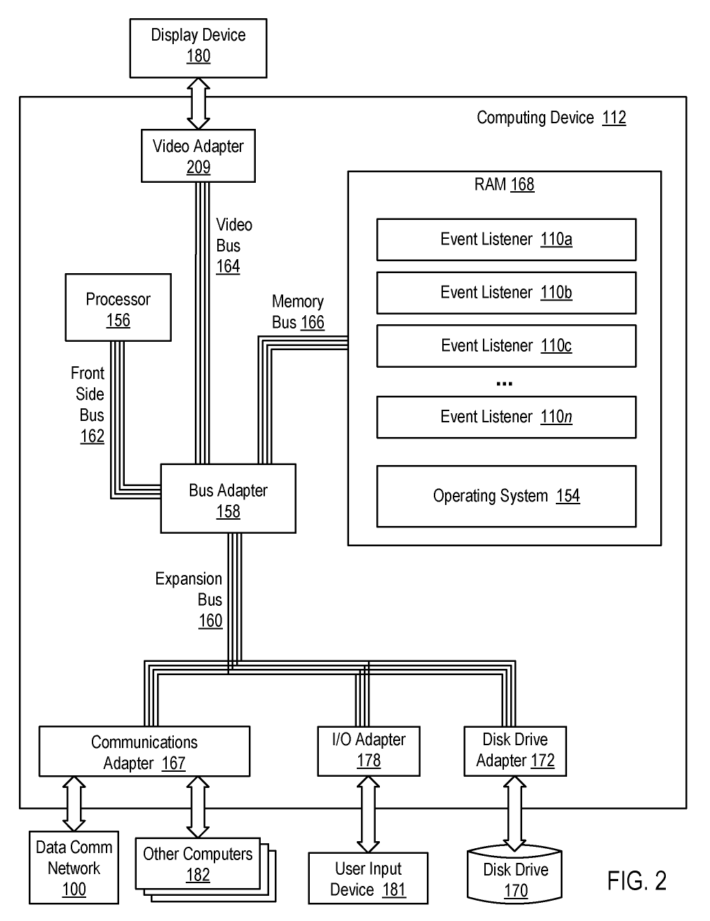

Creating a session log for a computing device being studied for usability in accordance with the present invention may be implemented with one or more computing devices, that is automated computing machinery. For further explanation, therefore, FIG. 2 sets forth a block diagram of automated computing machinery comprising an exemplary computing device (112) useful in creating a session log for a computing device being studied for usability according to embodiments of the present invention. The computing device (112) of FIG. 2 includes at least one computer processor (156) or ‘CPU’ as well as random access memory (168) (‘RAM’) which is connected through a high speed memory bus (166) and bus adapter (158) to processor (156) and to other components of the computing device.

Stored in RAM (168) are several event listeners (110). An event listener is a software component that detects the occurrence of an event that was generated as a result of user interaction with the device (112). The event listeners (110) of FIG. 2 may be able to detect the occurrence of events such as, for example, when a user depresses or releases a button on the device (112), when the user selects components on the device's graphical user interface, when software on the device processes a user's request or provides the user with output, and so on. An event listener may be implemented as interrupt handler, instrumentation code having instrumentation hooks embedded in other software components, a subroutine called by another software module, or any other implementation as will occur to those of skill in the art. In the example of FIG. 2, each event listener (110) operates for creating a session log for a computing device being studied for usability according to embodiments of the present invention. Each event listener (110) of FIG. 2 operates for creating a session log for a computing device being studied for usability according to embodiments of the present invention by detecting an event generated as a result of user interaction with the device and notifying the usability engine of the event.

Also stored in RAM (168) is an operating system (154). Operating systems useful in computing devices according to embodiments of the present invention include UNIX™, Linux™, Microsoft NT™, IBM's AIX™, IBM's i5/OS™, and others as will occur to those of skill in the art. The operating system (154) and the event listeners (110) in the example of FIG. 2 are shown in RAM (168), but many components of such software typically are stored in non-volatile memory also, for example, on a disk drive (170).

The exemplary computing device (112) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in computing devices useful according to embodiments of the present invention include the Intel Northbridge, the Intel Memory Controller Hub, the Intel Southbridge, and the Intel I/O Controller Hub. Examples of expansion buses useful in computing devices useful according to embodiments of the present invention may include Peripheral Component Interconnect (‘PCI’) buses and PCI Express (‘PCIe’) buses.

The exemplary computing device (112) of FIG. 2 also includes disk drive adapter (172) coupled through expansion bus (160) and bus adapter (158) to processor (156) and other components of the exemplary computing device (112). Disk drive adapter (172) connects non-volatile data storage to the exemplary computing device (112) in the form of disk drive (170). Disk drive adapters useful in computing devices include Integrated Drive Electronics (‘IDE’) adapters, Small Computer System Interface (‘SCSI’) adapters, and others as will occur to those of skill in the art. In addition, non-volatile computer memory may be implemented for a computing device as an optical disk drive, electrically erasable programmable read-only memory (so-called ‘EEPROM’ or ‘Flash’ memory), RAM drives, and so on, as will occur to those of skill in the art.

The exemplary computing device (112) of FIG. 2 includes one or more input/output (‘I/O’) adapters (178). I/O adapters in computing devices implement user-oriented input/output through, for example, software drivers and computer hardware for controlling output to display devices such as computer display screens, as well as user input from user input devices (181) such as keyboards and mice. The exemplary computing device (112) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing device (112) of FIG. 2 includes a communications adapter (167) for data communications with other computers (182) and for data communications with a high speed, low latency data communications network (100). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for creating a session log for a computing device being studied for usability according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary computing devices having installed upon them event listeners, readers will note that automated computing machinery used to implement exemplary computing devices having installed upon them usability engines useful in creating a session log for a computing device being studied for usability according to embodiments of the present invention are similar to the exemplary computing device (112) of FIG. 2. That is, such exemplary computing devices having installed upon them usability engines include one or more processors, bus adapters, buses, RAM, video adapters, communications adapters, I/O adapters, disk drive adapters, and other components similar to the exemplary computing device (112) of FIG. 2 as will occur to those of skill in the art.

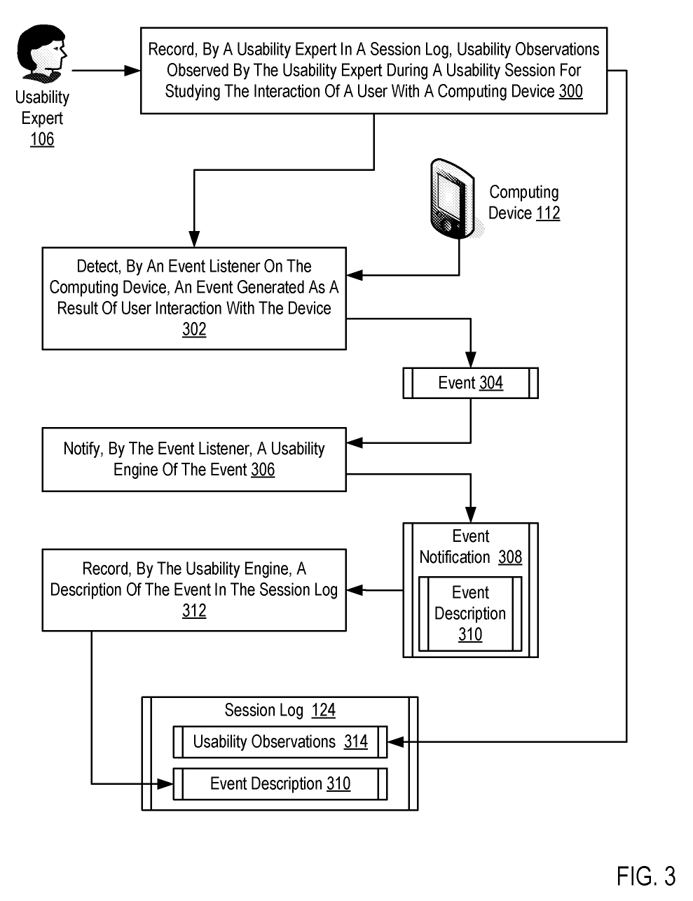

For further explanation, FIG. 3 sets forth a flow chart illustrating an exemplary method of creating a session log for a computing device being studied for usability according to embodiments of the present invention. The method of FIG. 3 includes recording (300), by a usability expert in a session log (124), usability observations (314) observed by the usability expert (106) during a usability session for studying the interaction of a user with a computing device (112). A usability observation is a description of any aspect of the user's interaction with the device that the usability expert (106) deems relevant to the usability study. For example, usability observations may describe the user's emotional state as the user operates the device (112), the speech spoken by the user to the device (112), the synthesized speech provided by the device (112) to the user, a description of how well the user appears to be operating the device, and any other aspect of the user's interaction that the usability expert (106) deems relevant to the usability study. A usability observation may include any interactions between the usability expert (106) and the user to administer the usability session. For example, a usability observation may include instructions provided by the usability expert (106) to the user and comments from the user to the usability expert (106). In the example of FIG. 3, the usability expert (106) may observe usability observations (314) by watching the user interact with the device (112) directly or by watching the user interact with the device (112) indirectly from a video recorded by a video recorder.

The usability expert (106) may record (300) the usability observations (314) in a session log (124) according to the method of FIG. 3 by entering the observations (314) into observation recorder software installed on the usability expert's computer. If the session log (124) is stored on the usability expert's computer, then the observation recorder software may then time stamp the observations entered by the expert (106) and write the usability observations (314) directly to the session log (124). However, if the session log (124) is stored on another computer, then the observation recorder software may time stamp the observations entered by the expert (106) and provide the expert's usability observations (314) to the computer on which the session log (124) is stored through a data communications connection.

The session log (124) of FIG. 3 represents a data structure that stores information provided by a usability expert that describes an interaction of a user with a computing device during a usability session and information provided by one or more event listeners that is generate as a result of the user interaction with the device. A session log may be implemented as a table of a database, text file, or any other implementation as will occur to those of skill in the art.

The method of FIG. 3 also includes detecting (302), by an event listener on the computing device, an event (304). An event (304) of FIG. 3 represents any event generated as a result of user interaction with the device (112). Examples of events may include when a user depresses or releases a button on the device (112), when the user selects components on the device's graphical user interface, when software on the device processes a user's request or provides the user with output, and any other event as will occur those of skill in the art. An event listener is a software component that detects the occurrence of an event that was generated as a result of user interaction with the device (112). An event listener may be implemented as interrupt handler, instrumentation code having instrumentation hooks embedded in other software components, a subroutine called by another software module, or any other implementation as will occur to those of skill in the art.

Because some event listeners may only be concerned with a single event and are only executed when the event occurs, such an event listener may detect (302) an event (304) according to the method of FIG. 3 by receiving processing control of the computing device's processor upon the occurrence of the event. Processing control may be transferred to an event listener using an interrupt or through a function call directed by another software module. In other embodiments, an event listener may detect (302) an event (304) according to the method of FIG. 3 by polling hardware registers or software variables to identify whether a particular event has occurred.

The method of FIG. 3 includes notifying (306), by the event listener, a usability engine of the event (304). A usability engine is a software component that receives event notifications from one or more event listeners and administers the session log (124). The event listener may notify (306) a usability engine of the event (304) according to the method of FIG. 3 by encapsulating a description (310) of the event in an event notification message (308) and transmitting the event notification message (308) to the usability engine. The event listener may transmit the event notification message (308) to the usability engine using any message passing mechanism as will occur to those of skill in the art, including web services, a CORBA framework, and Java RMI. The event notification message (308) of FIG. 3 represents a data structure for providing a usability engine with information regarding an event that occurred on the computing device (112) in response to a user's interaction with the device (112). The description (310) of the event in an event notification message (308) may include the following exemplary information:
Date, which specifies the date on which the event was detected;
Time, which specifies the time at which the event was detected;
Priority, which specifies the level of importance of the event;
Listener Identifier, which specifies the particular listener on the computing device that detected the event; and
Event Description, which provides event specific details concerning the event.

The method of FIG. 3 also includes recording (312), by the usability engine, a description (310) of the event (304) in the session log (124). The usability engine may record (312) a description (310) of the event (304) in the session log (124) according to the method of FIG. 3 by receiving the event notification message (308) provided by the event listener, extracting the description (310) of the event (304) from the event notification message (308), and storing the event description (310) in the session log (124).

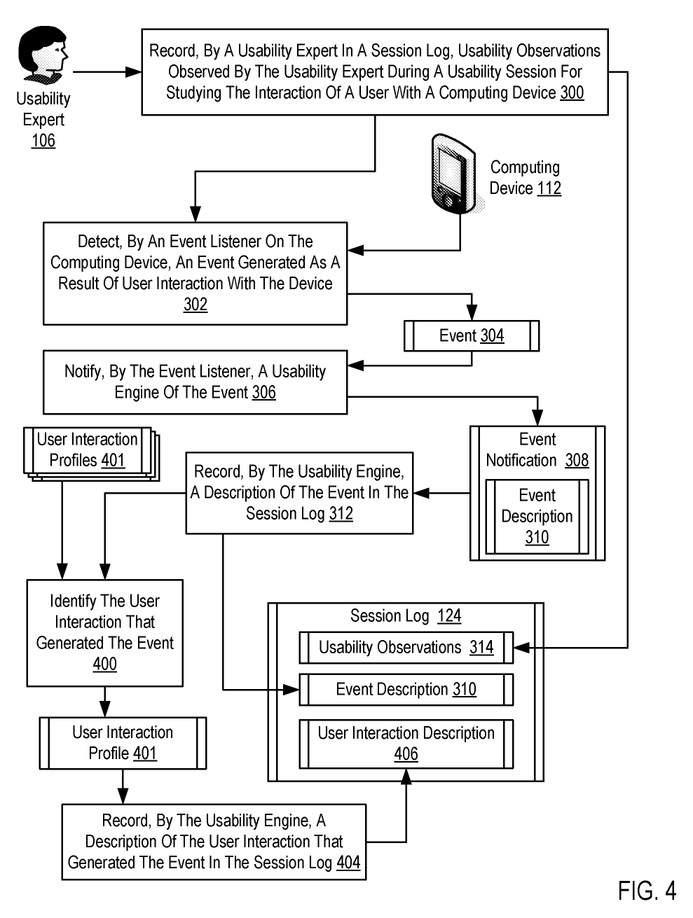

In addition to recording descriptions of events provided by event listeners in a session log, descriptions of the user interactions that generated the events may also be recorded in the session log. Rather than relying on a usability expert to identify these user interactions, however, the event listeners or the usability engine may be used to identify the user interaction that corresponds to one or more events. For further explanation, consider FIG. 4 that sets forth a flow chart illustrating a further exemplary method of creating a session log for a computing device being studied for usability according to embodiments of the present invention.

The method of FIG. 4 is similar to the method of FIG. 3. That is, the method of FIG. 4 includes recording (300), by a usability expert in a session log (124), usability observations (314) observed by the usability expert (106) during a usability session for studying the interaction of a user with a computing device (112); detecting (302), by an event listener on the computing device, an event (304) generated as a result of user interaction with the device; notifying (306), by the event listener, a usability engine of the event (304); and recording (312), by the usability engine, a description (310) of the event (304) in the session log (124).

The method of FIG. 4 also includes identifying (400) the user interaction (402) that generated the event (304). Either an event listener used to detect the event or the usability engine may be used to identifying (400) the user interaction (402) that generated the event (304) according to the method of FIG. 4. Typically, when the events of more than one event listener are used to identify (400) the user interaction (402), then the usability engine often identifies (400) the user interaction (402) that generated the events. Identifying (400) the user interaction (402) that generated the event (304) according to the method of FIG. 4 may be carried out by comparing the event description (310) to a set of user interaction profiles (401) and selecting the user interaction profile (401) satisfied by the event description (310).

A user interaction profile (401) represents a set of one or more events that are generated when a user interacts with the computing device (112) in a particular manner. In such a manner, a user interaction profile may associate a set of one or more events with a particular user interaction. For example, consider the following exemplary user interaction profile:

TABLE 1
EXEMPLARY USER INTERACTION PROFILE
SUCCESSFUL VOICE RECOGNITION

| | | HAS |
|---|---|---|
| EVENT ID | EVENT DESCRIPTION | OCCURRED |
| 1 | DevButtonListener: Depress Reco_Button | Yes |
| 2 | SpeechListener: StartListening | Yes |
| 3 | SpeechListener: RecoResult != NoMatch | No |

The exemplary user interaction profile above is a profile used to identify when the user experiences successful voice recognition. The exemplary profile includes three events. The first event description specifies that the user depressed the voice recognition button on the computing device. The second event description specifies that the device is listening for an utterance from the user. The third event description specifies that the speech recognition engine did not return a ‘NoMatch’ message, indicating that the speech recognition was successful. As the usability engine receives event description from event listeners that match events specified in a user interaction profile, the usability engine stores a value of ‘Yes’ in the ‘Has Occurred’ field for the event in the profile, indicating that that particular event specified by the profile has occurred. When the last remaining event specified by a user interaction profile occurs, the event description for that last remaining event is said to have ‘satisfied’ the user interaction profile. In the exemplary profile above, when an event listener notifies the usability engine that the speech recognition engine did not return a ‘NoMatch’ message, the event description provided by the event listener will have satisfied the exemplary user interaction profile above.

The method of FIG. 4 also includes recording (404), by the usability engine, a description (406) of the user interaction (402) that generated the event in the session log (124). The usability engine may record (404) a description (406) of the user interaction (402) that generated the event in the session log (124) according to the method of FIG. 4 by retrieving the description (406) of the user interaction from the selected user interaction profile (401), time stamping the description (406), and storing the description (406) in the session log (124). The description of the user interaction specified by each user interaction profile (401) may be stored in a user interaction description field of the user interaction profile (401).

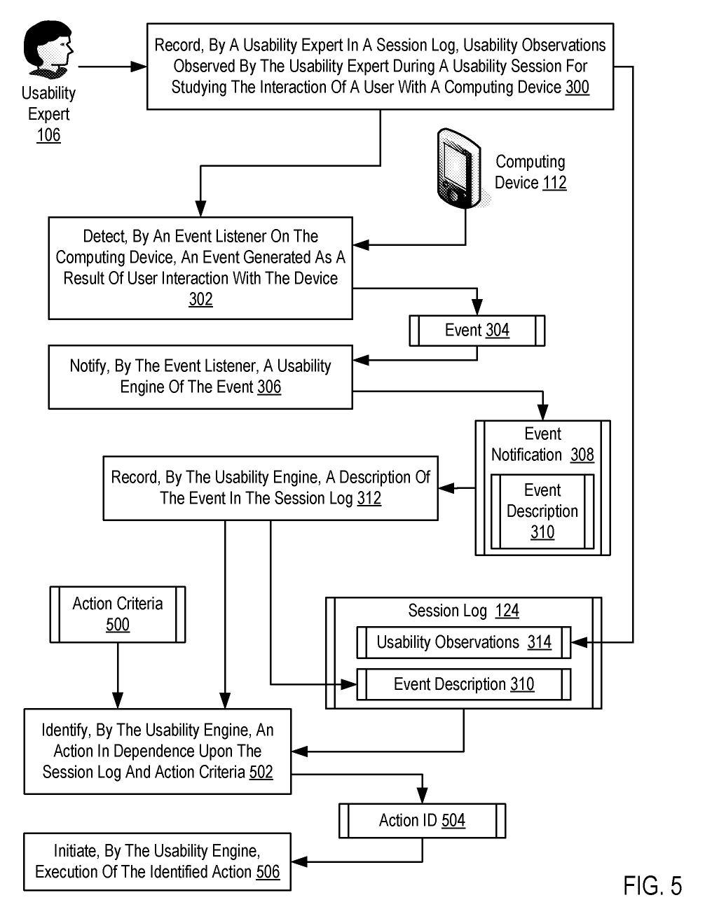

FIGS. 3 and 4 describe recording usability observations, event descriptions, and user interaction descriptions in a session log for a computing device being studied for usability. Based on the data recorded in such a session log, a usability engine may perform various actions. For further explanation, consider FIG. 5 that sets forth a flow chart illustrating a further exemplary method of creating a session log for a computing device being studied for usability according to embodiments of the present invention.

The method of FIG. 5 is similar to the method of FIG. 3. That is, the method of FIG. 5 includes recording (300), by a usability expert in a session log (124), usability observations (314) observed by the usability expert (106) during a usability session for studying the interaction of a user with a computing device (112); detecting (302), by an event listener on the computing device, an event (304) generated as a result of user interaction with the device; notifying (306), by the event listener, a usability engine of the event (304); and recording (312), by the usability engine, a description (310) of the event (304) in the session log (124).

The method of FIG. 5 also includes identifying (502), by the usability engine, an action in dependence upon the session log (124) and action criteria (500). The usability engine may identify (502) an action according to the method of FIG. 5 by parsing the session log (124) for event descriptions, determining whether the parsed event descriptions match an action rule in the action criteria (500), and selecting the action identifier (504) of the action rule matched by the parsed event descriptions.

The action criteria (500) of FIG. 5 represents a collection of action rules. Each action rule specifies a particular action to be performed when particular event condition is satisfied. Examples of actions specified by an action rule may include reconfiguring the device (112) being studied for usability, calling a helpdesk to provide assistance to the user interacting with the device (112) being studied for usability, or any other action as will occur to those of skill in the art. Reconfiguring the device (112) being studied for usability may be useful when the current configuration of the device results in poor usability. For example, a computing device (112) may be reconfigures with a different graphical user interface (‘GUI’) when the user repeatedly selects the wrong GUI component, cancels the selection, and then selects the proper GUI component. For further example, when a computing device (112) repeatedly has difficulty recognizing a user's speech, the computing device (112) may be reconfigured with a speech model that is tailor to the particular dialect of the user. Calling a helpdesk to provide assistance to the user interacting with the device (112) being studied for usability may be useful when the usability engine is unable to reconfigure the computing device (112) to enhance the user's experience with the device (112). Calling a helpdesk to provide assistance to the user interacting with the device (112) being studied for usability, however, may useful in lieu of attempting to reconfigure the computing device (112) to enhance the user's experience with the device (112) where the user successfully performs a particular task, but the usability engine recognizes that the user's experience with the device (112) could further be enhanced by performing the task in a different manner.

For further explanation, consider now exemplary action criteria (500) containing a collection of action rules that specify actions to be performed when particular event conditions are satisfied:

TABLE 2
EXEMPLARY ACTION CRITERIA

| ACTION ID | EVENT CONDITION |
|---|---|
| changeGUI(GUIptr) | (selectGUIcomp.#1 && selectCancel && |
| | selectGUIcomp.#2) HAS OCCURRED MORE |
| | THAN 3 TIMES |
| changeSpeechModel | (recoResult = NoMatch) HAS OCCURRED MORE |
| (speechModelptr) | THAN 5 TIMES WITHIN 3 MINUTES |
| helpDesk( ) | (email.login && email.denied) HAS OCCURRED |
| | MORE THAN 3 TIMES WITHIN 3 MINUTES |

The exemplary action criteria above contains three action rules. Each action rule includes an event condition and is identified by the function used to initiate a particular action upon the occurrence of the event condition. In the first action rule, the event condition specifies changing the GUI of the device when the user selects a particular GUI component, cancels the selection, and selects another GUI component more than three times. In the first action rule, the action identifier specifies the function ‘changeGUI(GUIptr)’ used to change the GUI of the device. In the second action rule, the event condition specifies changing the speech model of the device when a speech engine returns a ‘NoMatch’ result more than five times within three minutes. In the second action rule, the action identifier specifies the function ‘changeSpeechModel(speechModelptr)’ used to change the speech model of the device. In the third action rule, the event condition specifies calling a helpdesk when the user attempts to log on to the user's email using the device and is denied more than three times within three minutes. In the third action rule, the action identifier specifies the function ‘helpDesk( )’ used to initiate a call to a helpdesk.

The method of FIG. 5 also includes initiating (506), by the usability engine, execution of the identified action. The usability engine may initiate (506) execution of the identified action according to the method of FIG. 5 by extracting from the selected action identifier (504) the function specified by selected action identifier (504) and executing the extracted function. In the example of FIG. 5, the action identifier (504) is described as containing the function call used to initiate execution of a particular action. Readers will note, however, that this example is for explanation and not for limitation. In other embodiments, the usability engine may initiate (506) execution of the identified action according to the method of FIG. 5 by looking up the function used to initiate action execution in an action table using the selected action identifier (504).

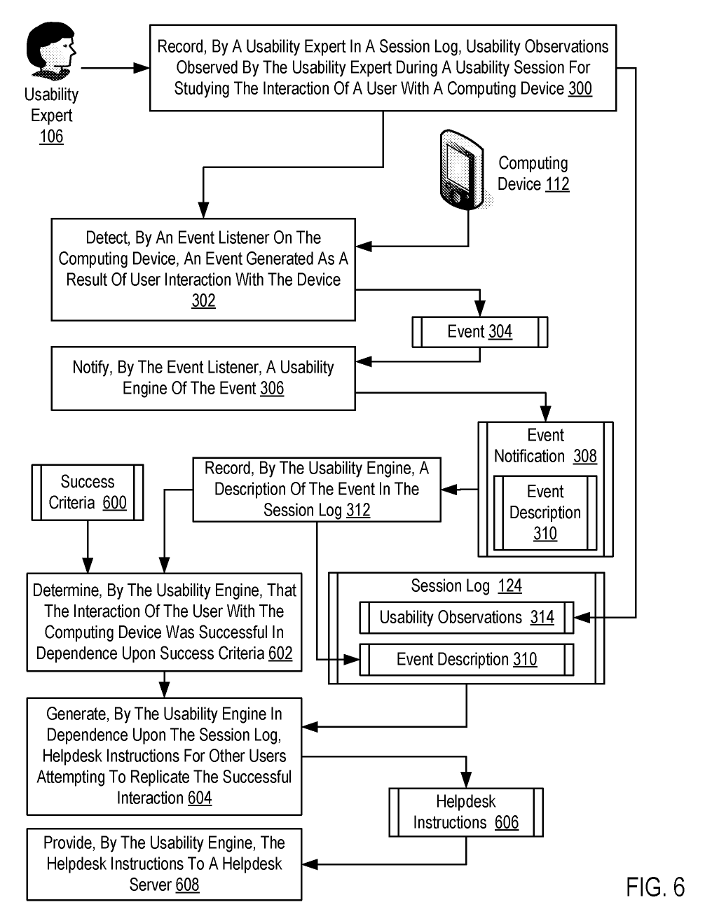

Readers will note that some interactions between users and a computing device may be more successful than others. For example, one user may use the device in a more efficient manner than other users. Usability sessions that record successful user interactions between the user and the device may be used to help other users desiring to replicate these successful user interactions. For further explanation, consider FIG. 6 that sets forth a flow chart illustrating a further exemplary method of creating a session log for a computing device being studied for usability according to embodiments of the present invention.

The method of FIG. 6 is similar to the method of FIG. 3. That is, the method of FIG. 6 includes recording (300), by a usability expert in a session log (124), usability observations (314) observed by the usability expert (106) during a usability session for studying the interaction of a user with a computing device (112); detecting (302), by an event listener on the computing device, an event (304) generated as a result of user interaction with the device; notifying (306), by the event listener, a usability engine of the event (304); and recording (312), by the usability engine, a description (310) of the event (304) in the session log (124).

The method of FIG. 6 also includes determining (602), by the usability engine, that the interaction of the user with the computing device was successful in dependence upon success criteria (600). Success criteria (600) of FIG. 6 may represent a set of success rules that identify whether a user interaction with the device is successful. For example, one success rule may identify a user interaction with a device is successful upon receiving an indication from the usability expert (106) that the user interaction was successful. When using success criteria (600) with this type of success rule, the usability engine may determine (602) that the interaction of the user with the computing device was successful according to the method of FIG. 6 by parsing the session log (124) for usability observations (314) recorded by the usability expert (106) and determining whether the parsed usability observations (314) indicate that the usability session was successful. Other success rules may be similar to the action rules in the action criteria discussed above with reference to FIG. 5. When using success criteria (600) with these types of success rules, the usability engine may determine (602) that the interaction of the user with the computing device was successful according to the method of FIG. 6 by parsing the session log (124) for event descriptions and determining whether the parsed event descriptions satisfy success conditions for any of the success rules of the success criteria (600).

The method of FIG. 6 includes generating (604), by the usability engine in dependence upon the session log (124), helpdesk instructions (606) for other users attempting to replicate the successful interaction. The helpdesk instructions (606) of FIG. 6 may be implemented as a list of step-by-step instructions that guide the user's interactions with the device (112) to generate the same events described in the session log (124). The step-by-step instructions may be a list of the actual event descriptions (310) recorded in the session log (124) or descriptions of the user interactions that generated the events as discussed above with reference to FIG. 4. As such, the usability engine may generate (604) helpdesk instructions (606) according to the method of FIG. 6 by parsing the session log (124) for event descriptions (310) or user interaction descriptions and rendering the parsed data as text, audio, or video using any number of synthesizers and codecs as will occur to those of skill in the art.

The method of FIG. 6 also includes providing (608), by the usability engine, the helpdesk instructions (606) to a helpdesk server. The usability engine may provide (608) the helpdesk instructions (606) to a helpdesk server according to the method of FIG. 6 by encapsulating the helpdesk instructions (606) into a helpdesk message and transmitting the helpdesk message to a helpdesk administration module on helpdesk server using a data communications connection implemented using, for example, web services, a CORBA framework, or Java RMI. The helpdesk administration module on the helpdesk server may then make the helpdesk instructions (606) available to other users attempting to replicate the successful user interaction recorded in the usability session.

Exemplary embodiments of the present invention are described largely in the context of a fully functional computer system for creating a session log for a computing device being studied for usability. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of creating a session log for a computing device being studied for usability, the method comprising:
recording, by a usability expert in a session log, usability observations observed by the usability expert during a usability session for studying the interaction of a user with a computing device;
detecting, by an event listener on the computing device, an event generated as a result of user interaction with the device;
notifying, by the event listener, a usability engine of the event; and
recording, by the usability engine, a description of the event in the session log.

2. The method of claim 1 further comprising:
identifying the user interaction that generated the event; and
recording, by the usability engine, a description of the user interaction that generated the event in the session log.

3. The method of claim 1 further comprising:
identifying, by the usability engine, an action in dependence upon the session log and action criteria; and
initiating, by the usability engine, execution of the identified action.

4. The method of claim 3 wherein the action further comprises reconfiguring the device being studied for usability.

5. The method of claim 3 wherein the action further comprises calling a helpdesk to provide assistance to the user interacting with the device being studied for usability.

6. The method of claim 1 further comprising:
determining, by the usability engine, that the interaction of the user with the computing device was successful in dependence upon success criteria;
generating, by the usability engine in dependence upon the session log, helpdesk instructions for other users attempting to replicate the successful interaction; and
providing, by the usability engine, the helpdesk instructions to a helpdesk server.

7. A system for creating a session log for a computing device being studied for usability, the system comprising:
means for recording, in a session log, usability observations observed by a usability expert during a usability session for studying the interaction of a user with a computing device;
means for detecting, on the computing device, an event generated as a result of user interaction with the device;
means for notifying a usability engine of the event; and
means for recording a description of the event in the session log.

8. The system of claim 7 further comprising:
means for identifying the user interaction that generated the event; and
means for recording a description of the user interaction that generated the event in the session log.

9. The system of claim 7 further comprising:
means for identifying an action in dependence upon the session log and action criteria; and
means for initiating execution of the identified action.

10. The system of claim 9 wherein the action further comprises reconfiguring the device being studied for usability.

11. The system of claim 9 wherein the action further comprises calling a helpdesk to provide assistance to the user interacting with the device being studied for usability.

12. The system of claim 7 further comprising:
means for determining that the interaction of the user with the computing device was successful in dependence upon success criteria;
means for generating, in dependence upon the session log, helpdesk instructions for other users attempting to replicate the successful interaction; and
means for providing the helpdesk instructions to a helpdesk server.

13. A computer program product for creating a session log for a computing device being studied for usability, the computer program product disposed upon a computer readable medium, the computer program product comprising computer program instructions capable of:
recording, by a usability expert in a session log, usability observations observed by the usability expert during a usability session for studying the interaction of a user with a computing device;
detecting, by an event listener on the computing device, an event generated as a result of user interaction with the device;
notifying, by the event listener, a usability engine of the event; and
recording, by the usability engine, a description of the event in the session log.

14. The computer program product of claim 13 further comprising computer program instructions capable of:
identifying the user interaction that generated the event; and
recording, by the usability engine, a description of the user interaction that generated the event in the session log.

15. The computer program product of claim 13 further comprising computer program instructions capable of:
identifying, by the usability engine, an action in dependence upon the session log and action criteria; and
initiating, by the usability engine, execution of the identified action.

16. The computer program product of claim 15 wherein the action further comprises reconfiguring the device being studied for usability.

17. The computer program product of claim 15 wherein the action further comprises calling a helpdesk to provide assistance to the user interacting with the device being studied for usability.

18. The computer program product of claim 13 further comprising computer program instructions capable of:
determining, by the usability engine, that the interaction of the user with the computing device was successful in dependence upon success criteria;
generating, by the usability engine in dependence upon the session log, helpdesk instructions for other users attempting to replicate the successful interaction; and
providing, by the usability engine, the helpdesk instructions to a helpdesk server.

19. The computer program product of claim 13 wherein the computer readable medium comprises a recordable medium.

20. The computer program product of claim 13 wherein the computer readable medium comprises a transmission medium.
